(19) United States
(12) Patent Application Publication
(10) Pub. No.: US 2004/0098888 A1
(43) Pub. Date: May 27, 2004

(54) Appliance utilizing water

(75) Inventors: Kazuhiro Ukida, Kakogawa-shi (JP); Tadafumi Kubo, Sanda-shi (JP); Haruo Ishikawa, Kobe-shi (JP)

Correspondence Address: BACON & THOMAS, PLLC, 625 SLATERS LANE, FOURTH FLOOR, ALEXANDRIA, VA, 22314

(73) Assignee: Matsushita Electric Industrial Co., Ltd., Osaka (JP)

(21) Appl. No.: 10/715,561

(22) Filed: Nov. 19, 2003

(30) Foreign Application Priority Data
Nov. 22, 2002 (JP) 2002-339068

(51) Int. Cl. G09F 3/10

(52) U.S. Cl. 40/299.01; 219/621

(57) ABSTRACT

An appliance or equipment utilizing water includes an operation section provided on top or side of a main body of the appliance and an outer member. The outer member includes a transparent member, a transparent film formed thereon, and a colored decoration provided on a surface of the transparent member opposite to the transparent film. The operation section is comprised of only the transparent film. In accordance with the appliance of the present invention, a transparent texture quality in outer appearance as well as a depth and classic texture quality in design can be obtained and at the same time a stereovision of characters or figures on an outer surface of the appliance can be provided.

### FIELD OF THE INVENTION

The present invention relates to an appliance or equipment utilizing water which has on top or side of a main body thereof an operation section for operating the appliance.

### BACKGROUND OF THE INVENTION

Referring to FIG. 7, there is illustrated a conventional water-utilizing appliance.

As shown in FIG. 7, outer case 51 of the appliance has recessed portion 56 for mounting therein outer member 55. Recessed portion 56 has operation section aperture 57 with which actuator 52a of control unit 52 is aligned, and pilot lamp aperture 58 through which pilot lamp 53 passes to indicate an operating status of the appliance in response to the operation of actuator 52a. Outer member 55 is formed of a resin and is integrated with waterproof film 59 in such a way that operation section 60 is comprised of only waterproof film 59 without any material of outer member 55. Further, outer member 55 is liquid-tightly secured on outer case 51 by adhesive 62 (see, e.g., Japanese Patent Laid-open Publication No. 1994-209849 (cols. 3 and 4, FIG. 1)).

In such a conventional appliance, wherein incursion of water into a main body of the appliance is avoided and operation section 60 is made of only waterproof film 59 for easy operation without any step or gap, the outer member thereof is normally made of a colored material so that no transparent texture quality can be provided, thereby failing to provide a depth and classic texture quality in design. Moreover, a stereovision of characters or figures on an outer surface of the appliance cannot be implemented.

### SUMMARY OF THE INVENTION

It is, therefore, an object of the present invention to provide a water-utilizing appliance which offers a transparent texture quality in outer appearance as well as a depth and classic texture quality in design and at the same time renders characters or figures on an outer surface of the appliance easily visible by implementing a stereovision thereof.

In accordance with an aspect of the present invention, there is provided an appliance utilizing water including: an operation section provided on top or side of a main body of the appliance; and an outer member including a transparent member, a transparent film formed thereon, and a colored decoration provided on a surface of the transparent member opposite to the transparent film, wherein the operation section is comprised of only the transparent film.

In accordance with the appliance of the present invention, a transparent texture quality in outer appearance thereof as well as a depth and classic texture quality in design can be provided and at the same time characters or figures on a surface of the appliance can be presented in a stereovision to thereby make them easily visible.

Preferably, a decoration may be added to a portion of the transparent film so that a stereovision of characters or figures on the surface of the appliance can be provided to thereby have them visible with ease.

Preferably, the decoration provided on the surface of the transparent member opposite to the transparent film may be formed by printing or painting in such a manner that the stereovision of characters or figures on a surface of the appliance can be further enhanced to render them readily visible.

In accordance with another aspect of the present invention, there is provided an appliance utilizing water including: an operation section provided on top or side of a main body of the appliance; and an outer member including a transparent member, a transparent film formed on a top surface of the transparent member, and a colored member integrally formed on a bottom surface of the transparent member, wherein the outer member has a portion comprised of only the transparent film and the operation section is disposed at the portion comprised of only the transparent film.

In accordance with the appliance described above, a transparent texture quality as well as a depth and classic texture quality in design thereof can be presented in outer appearance thereof at a low cost and at the same time a stereovision of characters or figures on a surface of the appliance can be provided to make them easily visible.

Preferably, a connection structure for fixing the outer member to the appliance may be provided to the colored member so that the outer member can readily be fixed to the main body in a mechanical and secure manner.

### BRIEF DESCRIPTION OF THE DRAWINGS

The above and other objects and features of the present invention will become apparent from the following description of preferred embodiments given in conjunction with the accompanying drawings, in which:

FIG. 1 is a cross sectional view showing a portion of an appliance utilizing water in accordance with a first preferred embodiment of the present invention;

FIG. 2 sets forth a cross sectional view of the appliance in accordance with the first preferred embodiment of the present invention;

FIG. 3 represents a top view of an appliance utilizing water in accordance with a second preferred embodiment of the present invention;

FIG. 4 depicts a cross sectional view of an appliance utilizing water in accordance with a fourth preferred embodiment of the present invention;

FIG. 5 offers a cross sectional view showing a portion of the appliance in accordance with the fourth preferred embodiment of the present invention;

FIG. 6 shows a cross sectional view showing a portion of an appliance utilizing water in accordance with a fifth preferred embodiment of the present invention; and

FIG. 7 illustrates a cross sectional view showing a portion of a conventional water-utilizing appliance.

### DETAILED DESCRIPTION OF PREFERRED EMBODIMENTS

Preferred embodiments of the present invention will now be described with reference to the accompanying drawings by taking a rice cooker as an example.

### First Embodiment

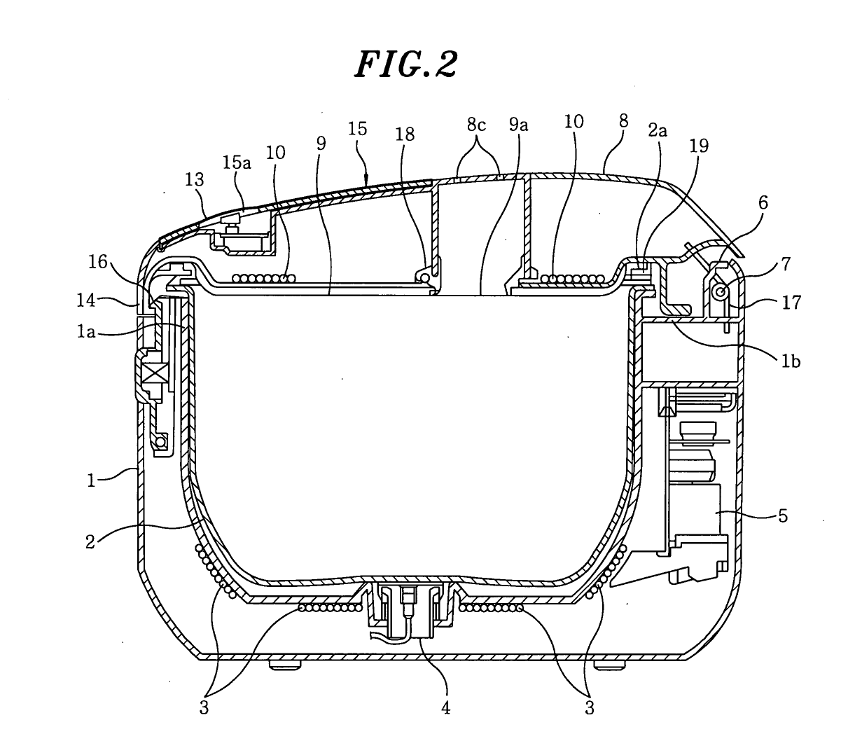

As shown in FIG. 2, main body 1 of an appliance or equipment which utilizes water, e.g., a rice cooker, includes cooker receiving part 1a in which pot 2 is removably accommodated. As a unit for heating pot 2, bottom induction coils 3 are disposed under a bottom of pot receiving part 1a to heat pot 2 for cooking or warming the rice therein. Bottom sensor 4 detects a temperature of pot 2 and sends a signal therefor to control unit 5. Control unit 5 controls an amount of a current flowing through bottom induction coils 3, i.e., a heating amount thereof in response to the signal from bottom sensor 4, thereby adjusting the temperature of pot 2 to be suitable for a cooking or warming function.

Cover 8 for closing and opening top of main body 1 is pivotably mounted to hinge shaft 7 which is disposed at hinge unit 6 on the rear side of main body 1. Hook member 14 is provided to a front end portion of cover 8 and engaged with front hook button 16 while cover 8 closes the top of main body 1, thereby preventing cover 8 from being opened. By pushing hook button 16, hook member 14 is disengaged from hook button 16 and cover 8 is opened by a spring force of hinge spring 17 installed at hinge unit 6.

Vapor generated during a cooking or warming operation of the rice cooker is gathered on an inner surface of cover 8 to thereby be condensed to stream down onto upper edge portion 1b of main body 1 when cover 8 is opened or to drop onto the rice during the warming operation to whiten the rice. In order to prevent the above problems, heating plate 9 for heating inside of pot 2 is installed in cover 8. Heating plate 9 is heated by cover induction coils 10 as a unit for heating cover 8 so that the condensation on cover 8 is avoided during the cooking and the warming operation.

Heating plate 9 has vapor port 9a through which vapor generated during the cooking or warming operation is discharged to outside via vapor holes 8c of cover 8. Vapor port packing 18 is disposed around vapor port 9a to prevent vapor from entering inside of cover 8. Further, pot packing 19 prevents vapor from being discharged to the outside between heating plate 9 and flange portion 2a of pot 2.

Provided in cover 8 is operation section 13 for operating the pot heating unit and the cover heating unit. In case operation section 13 is provided in cover 8, a user can manipulate operation section 13 regardless of an orientation of the rice cooker and a space required for the placement of the appliance is reduced.

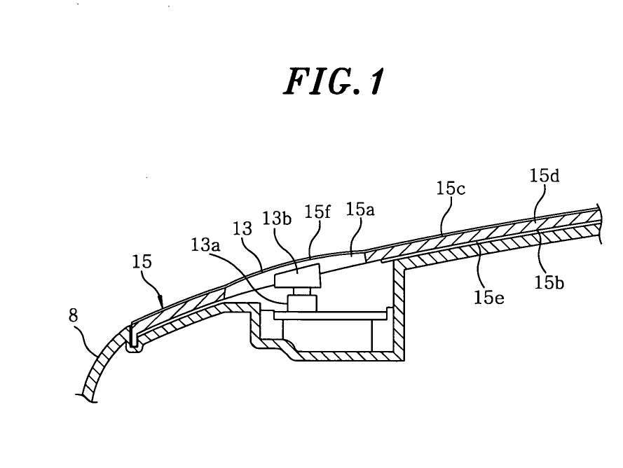

As shown in FIG. 1, a portion of cover 8 is covered with outer member 15 including transparent member 15d made of ABS resin, polycarbonate resin, acrylic resin or the like and transparent film 15c of, e.g., polyethylene terephtalate resin with a thickness in a range from about 0.05 mm to about 0.3 mm integrally formed thereon. Outer member 15 has opening portion 15a comprised of only transparent film 15c. Transparent member 15d has a thickness ranging from about 1 mm to 3 mm, which is greater than that of transparent film 15c.

Operation section 13 is located at opening portion 15a of outer member 15. Provided at opening portion 15a is embossed section 15f comprised of only transparent film 15c which serves as a push button. The user may push embossed section 15f to actuate switch 13a via key 13b disposed against embossed section 15f. Colored decorations 15e are added to surface 15b of transparent member 15d opposite to transparent film 15c.

Functions of the above arrangements will now be described. Decoration 15e is seen through transparent film 15c and transparent member 15d to thereby present a transparent texture quality in outer appearance, which in turn makes it possible to provide a depth and classic texture quality in design. The thicker transparent member 15d is, the better the transparent texture quality becomes.

For instance, in case the thickness of transparent film 15c is made to range from about 0.05 mm to about 0.3 mm in considering a maneuverability of operation section 13 and the thickness of transparent member 15d ranges from about 1 mm or greater, the transparent texture quality improves enough to provide a significant depth and classic texture quality in design.

In addition, in a cooker such as the rice cooker of this embodiment, outer member 15 is required to be resistant against heat and vapor generated during a cooking operation. However, there is no limitation on heat-resistance due to decorations on a surface film as is the case in the prior art and it is also possible to use polycarbonate resin for outer member 15. Therefore, it is possible to increase heat-resistance thereof.

Further, in this embodiment, although operation section 13 is provided in cover 8 which covers and opens the top of main body 1, operation section 13 may be provided in main body 1 and covered with outer member 15 as described above without losing any improvements in design achieved in the embodiment.

While, in this embodiment, the invention has been described by taking the rice cooker as an example, the arrangements described above may be applied to an appliance using water such as other cookers, a washing machine, a dish washer or a hot water supplier.

### Second Embodiment

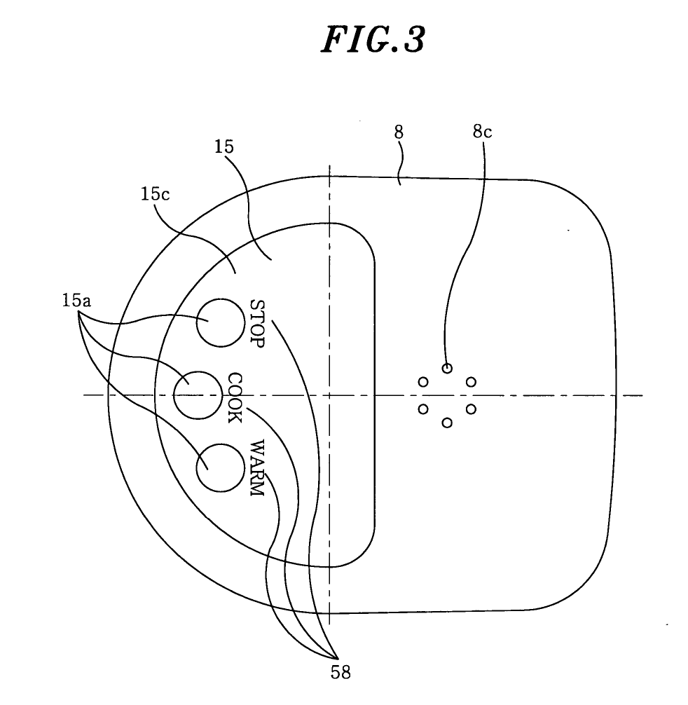

In accordance with a second embodiment of the present invention, as shown in FIG. 3, outer member 15 forms an outer portion of cover 8 and decorations 58 such as characters or figures are added to a portion of transparent film 15c. The other constitutions are same as those of the first embodiment.

With such arrangements, since decorations 58 such as characters or figures are added to transparent film 15c, their shadows are projected on a bottom surface of outer member 15 through transparent film 15d. As a result, a stereovision of characters or figures can be obtained.

For example, characters indicating operation modes of operation section 13 are seen in three dimensions so that they become readily visible. Figures are also represented in three dimensions, thereby emphasizing a transparent texture quality in outer appearance as well as a depth and classic texture quality in design thereof.

### Third Embodiment

The third embodiment is same as the first or the second embodiment except that colored decorations 15e shown in FIG. 1 or decorations 58 such as characters or figures shown in FIG. 3 are painted or printed.

In the third embodiment, decorations 15e in FIG. 1 or decorations 58 in FIG. 3 can easily be added on a corresponding entire surface by printing. Further, by selecting a color of the painting such that the characters or figures on the surface become readily visible, the stereovision of the characters or figures may be emphasized.

In addition, multi-colored characters or figures can be obtained by printing so that a better design can be drawn, and the characters or figures may also be exhibited in three dimensions to thereby make them visible with ease like the painting.

### Fourth Embodiment

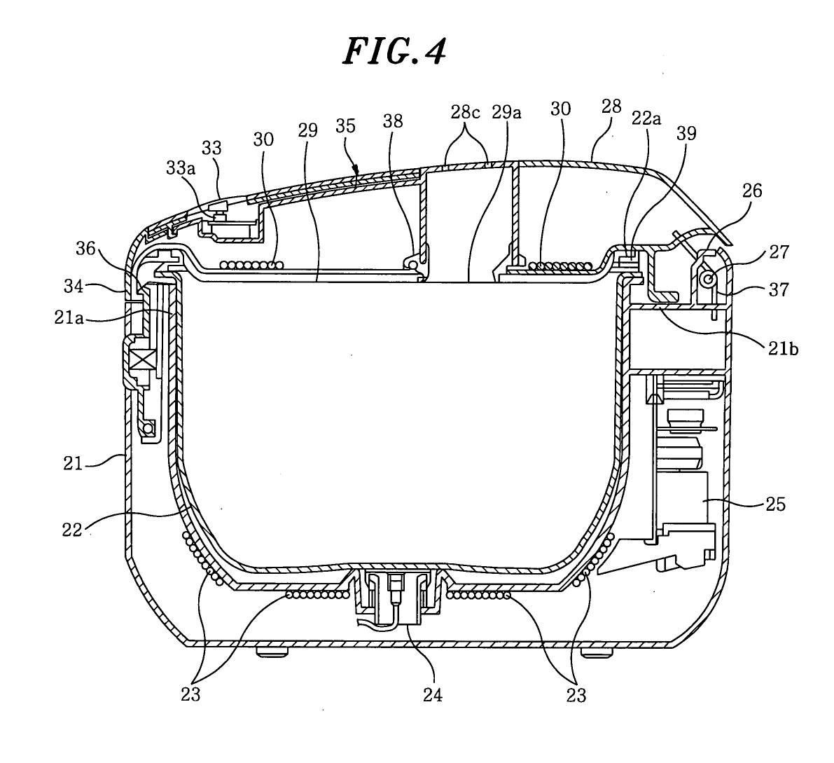

As shown in FIG. 4, main body 21 of a rice cooker includes cooker receiving part 21a in which pot 22 is removably accommodated. As a unit for heating pot 22, bottom induction coils 23 are disposed under a bottom of pot receiving part 21a to heat pot 22 for cooking or warming the rice therein. Bottom sensor 24 detects a temperature of pot 22 and sends a signal therefor to control unit 25. Control unit 25 controls an amount of a current flowing through bottom induction coils 23, i.e., a heating amount thereof in response to the signal from bottom sensor 24, thereby adjusting the temperature of pot 22 to be suitable for a cooking or warming function.

Cover 28 for closing and opening top of main body 21 is pivotably mounted to hinge shaft 27 which is disposed at hinge unit 26 on the rear side of main body 21. Hook member 34 is provided to a front end portion of cover 28 and engaged with front hook button 36 while cover 28 closes the top of main body 21, thereby preventing cover 28 from being opened. By pushing hook button 36, hook member 34 is disengaged from hook button 36 and cover 28 is opened by a spring force of hinge spring 37 installed at hinge unit 26.

Vapor generated during a cooking or warming operation of the rice cooker is gathered on an inner surface of cover 28 to be condensed to stream down onto upper edge portion 21b of main body 21 when cover 28 is opened or to drop onto the rice during the warming operation to whiten the rice. In order to prevent the above problems, heating plate 29 for heating inside of pot 22 is installed in cover 28. Heating plate 29 is heated by cover induction coils 30 as a unit for heating cover 28 so that the condensation on cover 28 is avoided during the cooking and the warming operation.

Heating plate 29 has vapor port 29a through which vapor generated during the cooking or warming operation is discharged to outside via vapor holes 28c of cover 28. Vapor port packing 38 is disposed around vapor port 29a to prevent vapor from entering inside of cover 28. Further, pot packing 39 prevents vapor from being discharged to the outside between heating plate 29 and flange portion 22a of pot 22.

Provided in cover 28 is operation section 33 for operating the pot heating unit and the cover heating unit. In case operation section 33 is provided in cover 28, a user can manipulate operation section 33 regardless of an orientation of the rice cooker and a space required for the placement of main body 21 of the rice cooker appliance is reduced.

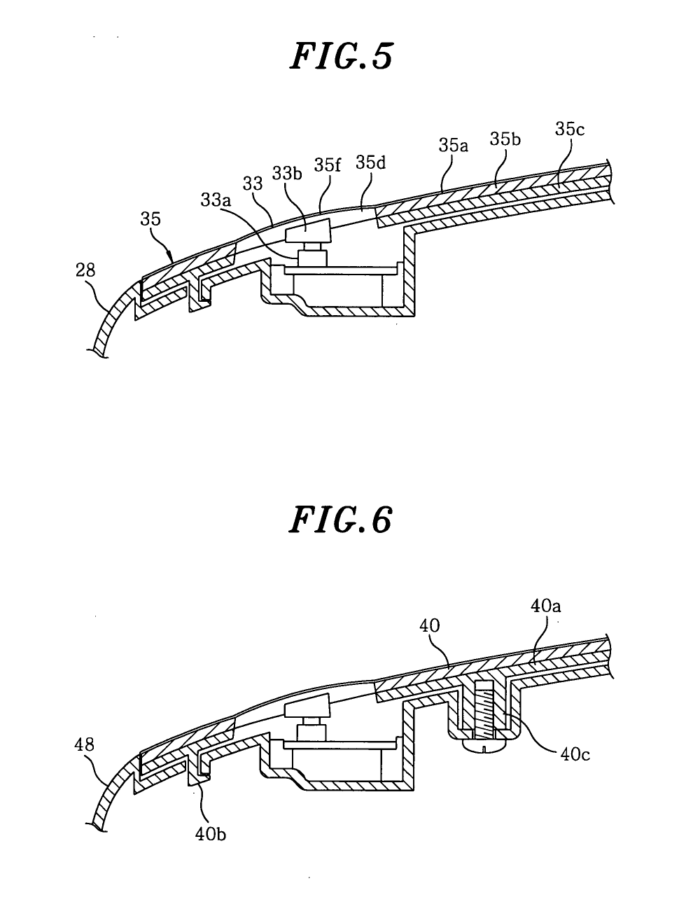

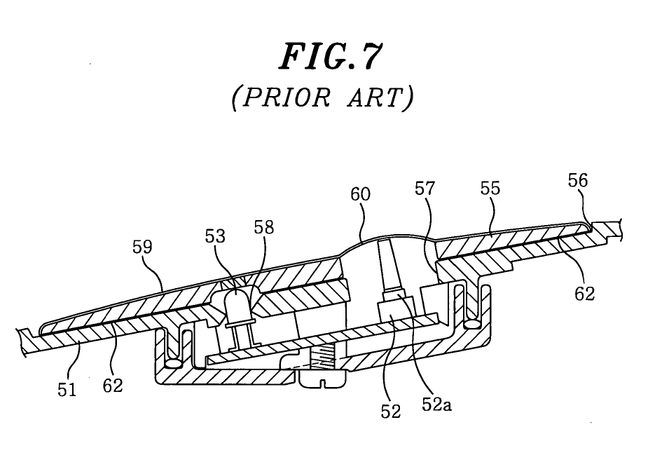

As shown in FIG. 5, a portion of cover 28 is covered with outer member 35 including transparent member 35b made of ABS resin, polycarbonate resin, acrylic resin or the like; underlying colored member 35c; and transparent film 35a of, e.g., polyethylene terephtalate resin with a thickness ranging from about 0.05 mm to about 0.3 mm integrally formed on transparent member 35b. Outer member 35 has opening portion 35d comprised of only transparent film 35a.

Transparent member 35b has a thickness ranging from about 1 mm to 3 mm, which is greater than that of transparent film 35a. Colored member 35c is formed of a colored material identical to that of transparent member 35b or a colored material tightly formable with transparent member 35b. For example, when transparent member 35b is made of acrylic resin, colored member 35c is made of colored acrylic resin or ABS resin.

Operation section 33 is located in opening portion 35d of outer member 35. Provided in opening portion 35d is embossed section 35f comprised of only transparent film 35a which serves as a push button. The user may push embossed section 35f to actuate switch 33a via key 33b disposed against embossed section 35f.

Functions of the above arrangements will now be described. Since the user sees colored member 35c through transparent film 35a and transparent member 35b, a transparent texture quality in the outer appearance can be provided, which in turn provides a depth and classic texture quality in design.

Here, the thicker transparent member 15d is, the better the depth and classic texture quality becomes. For instance, in case the thickness of transparent film 35a is made to be in a range from about 0.05 mm to about 0.3 mm in considering a maneuverability of operation section 33 and the thickness of transparent member 35b ranges from about 1 mm or greater, the transparent texture quality improves enough to provide a significant depth and classic texture quality in design.

In addition, when decorations such as characters or figures are added to transparent film 35a, their shadows are projected on colored member 35c through transparent member 35b. As a result, a stereovision of characters or figures can be obtained, thereby providing a depth and classic texture quality in design.

Moreover, by an integral forming, colored member 35c can be seen through transparent film 35a and transparent member 35b without any stain, thereby exhibiting a stable transparent texture quality and increasing a yield thereof. In addition, since transparent film 35a, transparent member 35b and colored member 35c are made of resins by an integral molding method, the transparent texture quality in outer appearance can be obtained at a low cost and outer member 35 can be made rigid by increasing the thickness thereof.

Further, in this embodiment, although operation section 33 is provided in cover 28 which covers and opens the top of main body 21, operation section 33 may be provided in main body 21 and covered with outer member 35 as described above without losing any improvements in design achieved in this embodiment.

While, in this embodiment, the invention has been described by taking the rice cooker as an example, the arrangements described above may be applied to an appliance using water such as other cookers, a washing machine, a dish washer or a hot water supplier.

### Fifth Embodiment

As shown in FIG. 6, provided to colored member 40a of outer member 40 is a connection structure for fixing outer member 40 to cover 48. The connection structure includes claw 40b and/or boss 40c into which a screw is screw-fitted. The other constitutions are same as those of the fourth embodiment.

Outer member 40 is comprised of multiple layers which have different contraction/expansion rates depending on heat or aging deterioration. Therefore, in case outer member 40 is employed in an appliance which uses water and to which heat is applied, it may be deformed or bent when experiencing an excessive heat or when being used for an extended time period, so that outer member 40 is required to be fixed by an adhesive, a fitting connection or a screwing connection.

In this embodiment, outer member 40 is securely connected to main body 21 or cover 48 by engaging claw 40b of colored member 40a with main body 21 or cover 48 and/or by fitting a screw through main body 21 or cover 48 into boss 40b of colored member 40a. As a result, claw 40b and/or boss 40c are not seen from outside, thereby securely fixing outer member 40 to main body 21 or cover 48 without deteriorating the transparent appearance thereof. In addition, no adhesive is required to secure outer member 40 to main body 21 or cover 48, thereby shortening a time period required therefor.

While the invention has been shown and described with respect to the preferred embodiment, it will be understood by those skilled in the art that various changes and modifications may be made without departing from the spirit and scope of the invention as defined in the following claims.

What is claimed is:

1. An equipment utilizing water comprising:
an operation section provided on top or side of a main body of the appliance; and
an outer member including a transparent member, a transparent film formed thereon, and a colored decoration provided on a surface of the transparent member opposite to the transparent film, wherein the operation section is comprised of only the transparent film.

2. The equipment of claim 1, wherein a decoration is added to a portion of the transparent film.

3. The equipment of claim 1, wherein the decoration provided on the surface of the transparent member opposite to the transparent film is formed by printing or painting.

4. The equipment of claim 2, wherein the decoration provided on the surface of the transparent member opposite to the transparent film is formed by printing or painting.

5. An equipment utilizing water comprising:
an operation section provided at top or side of a main body of the appliance; and
an outer member including a transparent member, a transparent film formed on a top surface of the transparent member, and a colored member integrally formed on a bottom surface of the transparent member, wherein the outer member has a portion comprised of only the transparent film and the operation section is disposed at the portion comprised of only the transparent film.

6. The equipment of claim 5, wherein a connection structure for fixing the outer member to the appliance is provided to the colored member.
